(19) United States
(12) Patent Application Publication
(10) Pub. No.: US 2006/0054655 A1
(43) Pub. Date: Mar. 16, 2006

(54) Selective reinforcement of metallic bodies

(76) Inventors: Rajiv S. Mishra, Rolla, MO (US); Joseph W. Newkirk, Rolla, MO (US)

Correspondence Address: SENNIGER POWERS, ONE METROPOLITAN SQUARE, 16TH FLOOR, ST LOUIS, MO, 63102, US

(21) Appl. No.: 10/927,215

(22) Filed: Aug. 26, 2004

(51) Int. Cl. B23K 20/12

(52) U.S. Cl. 228/2.1

(57) ABSTRACT

A method of making composite structural components including beams and other structural components involving incorporating a reinforcing segment into a metallic body by, for example, friction stir processing.

### FIELD OF THE INVENTION

This invention relates to composite structural components for use in applications where stiffness is required. These applications range from conventional applications such as support beams in aircraft, automotive, and other structures, to other industrial applications, to applications as diverse as sporting goods (e.g. tennis rackets, golf club faces), medical implants, bridge beams, and armor for military vehicles.

### BACKGROUND OF THE INVENTION

Structural components such as beams for aircraft frames, other aircraft components, automotive chassis, and other components, and many other load-bearing components, are constructed from metals such as Al, Ti, other metals, and alloys thereof because these materials provide relatively high stiffness at a lower weight than conventional steels. In the transport sector, including aircraft, spacecraft, watercraft, automobiles, trucks, trains, etc., weight savings is of paramount importance because it directly impacts travel-range and fuel consumption. Weight savings can also extend the life of existing structural supports including bridge supports, by permitting an existing horizontal beam to be replaced with a wider beam without replacing vertical supports.

The weight and stiffness of a structural component are design limitations in that for a given mass of material, the stiffness provided is limited by the material's modulus of elasticity. As a corollary, if a given stiffness is required, allowance must be made for the weight of material which provides such stiffness, as determined by the modulus of elasticity.

U.S. Pat. No. 5,384,087 discloses a powder metallurgical method of forming an aluminum strip reinforced with silicon carbide, and discusses previous composite manufacturing methods and patents in its background section.

### SUMMARY OF THE INVENTION

Among the many objects of the invention, therefore, is to provide a structural component which exceeds stiffness expectations based on the modulus of elasticity of the material.

Briefly, therefore, the invention is directed to a method of increasing a modulus of elasticity of a structural beam which comprises a metallic body having a body depth extending from a top surface of the metallic body to an opposing bottom surface of the metallic body. The method comprises incorporating a reinforcing segment into the metallic body by friction stir processing to form a composite structural beam comprising the metallic body and the reinforcing segment. The reinforcing segment comprises a reinforcing composition mixed with material of the metal body. The reinforcing composition is a material distinct from the material of the metallic body and has a modulus of elasticity which is greater than a modulus of elasticity of the material of the metallic body.

In another aspect the invention is directed to a method of making a composite structural component, involving incorporating a reinforcing segment into a metallic body by friction stir processing to form the composite structural component comprising the metallic body and the reinforcing segment. The reinforcing segment occupies a reinforcing segment depth extending to at least about 0.5 mm beneath the top surface of the metallic body and terminating within the metallic body.

The invention is also directed to a method of making a composite locally reinforced structural component comprising a metallic body, the method comprising incorporating a local reinforcing segment into the metallic body to form the composite locally reinforced structural component comprising the metallic body and the reinforcing segment. The local reinforcing segment comprises a reinforcing composition mixed with material of the metallic body. The reinforcing composition is a material distinct from the material of the metallic body and has a modulus of elasticity which is greater than a modulus of elasticity of the material of the metallic body. The local reinforcing segment has a local reinforcing segment width and a local reinforcing segment depth beginning at or beneath the first surface of the metallic body and terminating within the metallic body. The proportion of the reinforcing composition in the local reinforcing segment and the depth of the reinforcing segment are selected as a function of a predicted stiffness of the composite locally reinforced structural component in comparison to a predicted stiffness of a monolithic structural component having an overall proportion of reinforcing composition equivalent to an overall proportion of reinforcing composition in the locally reinforced structural component calculated as a function of the reinforcing composition proportion in the local reinforcing segment and the local reinforcing segment depth.

Other objects and features of this invention will be in part apparent and in part pointed out hereinafter.

### BRIEF DESCRIPTION OF THE DRAWINGS

FIG. 1 is a schematic illustration of a reinforced metallic body of the invention.

FIG. 2 is a schematic illustration of a load applied to a beam.

FIG. 3 is a schematic illustration of a friction stir apparatus for carrying out the invention.

FIG. 4 is a schematic illustration of a component of the apparatus of FIG. 3.

FIG. 5 is a schematic illustration of a component of a threaded friction stir tool.

FIG. 6 is a schematic illustration of an apparatus for carrying out the invention.

FIGS. 7 and 8 are schematic illustrations of cluster friction stir tools.

FIG. 9 is a graphical representation of data generated in a working example of the invention.

FIGS. 10 and 11 are photographs of reinforced metallic bodies of the invention shown in cross-section.

### DETAILED DESCRIPTION OF THE PREFERRED EMBODIMENTS

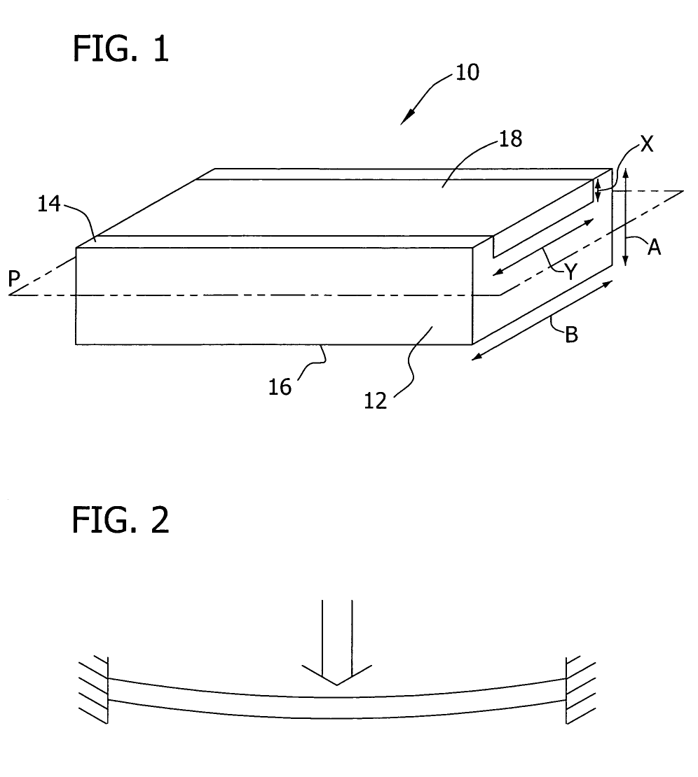

This invention provides structural components of enhanced stiffness, so that greater stiffness can be achieved without an increase in weight, or less weight of material can be used without a sacrifice in stiffness. It has been discovered that by incorporating a volume percent of reinforcing composition into a metallic body at a specific location in the manner shown generally and schematically in FIG. 1, preferably by friction stir processing, a composite structural component can be formed which has enhanced stiffness. In one embodiment the structural component is specifically a beam, which is defined as a body with one dimension large compared with other dimensions, whose function is to carry bending movements and lateral loads, which are loads perpendicular to the large dimension. In other embodiments the structural component is not strictly a beam.

Stiffness is a measure of elasticity and is typically characterized metallurgically as modulus of elasticity or Young's modulus. If a first component is characterized as stiffer than a second component, the first component requires a greater load to produce a given amount of elastic deflection. So, if a 100 kilogram load produces one millimeter of deflection in a first component and two millimeters of deflection in a second component, the first component is said to be stiffer than the second component. Stiffness is distinguished from yield strength in that yield strength refers to a component's resistance to plastic deformation. Yield strength is quantified as the amount of stress required for plastic deformation, specifically referring to a transition from elastic to plastic deformation.

In one embodiment the invention is a structural component which is expected to carry a substantial primary load in essentially only one direction. An example is a floor support beam for a military transport plane. As equipment is repeatedly loaded into and out of the plane, and a load as depicted by the arrow in FIG. 2 is generated, each floor support beam undergoes tensile stress on its bottom side and compressive stress on its top side. The same is true for an automotive bumper or side impact beam. Such components rarely if ever experience a significant load from the side opposite the primary load side. In this embodiment the invention involves selectively reinforcing the structural component against compressive stress on its primary load side. This is achieved as in FIG. 1 by incorporating a reinforcing composition section 18 into the metal body 12, which in this depiction constitutes the bulk of the structural component 10, where the reinforcing composition is a material which has a greater modulus of elasticity than the material of the metal body 12. An example is incorporation of SiC as reinforcing material into an Al alloy (5083 Al) beam. Other examples of metal body materials which can be reinforced in accordance with this invention include Cu, Cu-based alloys, Ti, Ti-based alloys, steel, and others. Examples of other reinforcing compositions include materials having a higher modulus than the metal body material, such as WC, B₄C, TiC, carbides, TiB₂, AlN, Al₂O₃, Nb in a Cu matrix, cermets, cermets of carbides in a matrix such as Co, Al, or Ni, and others.

In carrying out the invention it is preferable to select a volume fraction of reinforcing material and a location for reinforcement which advantageously achieve a predicted stiffness greater than that predicted by the rule of mixtures. In particular, it is known from, for example, Ashby et al., Designing Hybrid Materials, that under the rule of mixtures as a guiding principle for modulus, the maximum modulus (i.e., stiffness) of a composite is predictable by the following equation:
M_{comp}=fMᵣ+(1−f)Mₘ

where M_{comp} is the modulus of the composite, f is the volume fraction of the reinforcement section, Mᵣ is the modulus of the material used for reinforcement, and Mₘ is the modulus of the material constituting the bulk. More precise limits can be predicted, but such more precise limits are always lower than limits predicted by the rule of mixtures. With the present invention, however, predicted values are reached which exceed the maximum predicted values according to the rule of mixtures. In particular, it has been discovered that by following certain critical criteria for selection of reinforcement location and reinforcement fraction, unexpectedly high stiffness can be achieved.

In accordance with this invention, structural components are designed and made to have an enhanced stiffness by careful selection of a) location of the reinforcement segment, b) dimension of the reinforcement segment, and c) vol. % reinforcing material (i.e., loading) in the reinforcement segment. In particular, it has been discovered that these parameters can be selected to achieve synergistic results. That is, they can be selected to achieve a predicted stiffness which is greater than the predicted stiffness of a monolithic beam of the same overall composition.

With specific reference to FIG. 1, structural component 10 has a metallic body 12 which has a body depth A extending from a first surface 14 of the metallic body (the upper surface in the orientation in FIG. 1) to an opposing second surface 16 (the underneath surface not visible in FIG. 1). The first surface corresponds to a surface of the structural component in compression under primary loading conditions for which the structural component is designed, such as downwardly. The second surface corresponds to a surface of the structural component in tension under primary loading conditions for which the structural component is designed. Local reinforcing segment 18 is incorporated into the metallic body to thereby form a composite locally reinforced structural component comprising the metallic body 12 and the reinforcing segment 18.

The local reinforcing segment 18 has a composition distinct from a composition of the metallic body 12. In one example, the reinforcing segment constitutes a proportion of SiC in an Al alloy composition, and the metallic body has an Al alloy composition. For example, the reinforcing segment is 10 vol. % SiC and 90 vol. % 5083 Al, and the metallic body is 100% 5083 Al alloy. The local reinforcing segment is made up of two components: the reinforcing composition and the main base metal. In one sample arrangement, the local reinforcing segment comprises a proportion of the reinforcing composition (SiC) admixed with the metallic body composition (5083 Al).

The local reinforcing segment is dimensionally defined by a local reinforcing segment width Y and a local reinforcing segment depth X beginning at or beneath the first surface of the metallic body 12 and terminating within the metallic body. In one embodiment, the local reinforcing segment depth X extends to at least about 10% of the depth A of the metallic body. In another embodiment the local reinforcing segment depth X extends to at least about 20% of the depth A of the metallic body. For example, the depth of the reinforcing segment is at least about 0.5 mm. In one embodiment, the depth of the reinforcing segment is at least about 1 mm, or at least about 3 mm, in a metallic body which is on the order of 12 to 13 mm thick. The local reinforcing segment depth X does not intersect the longitudinal central plane P of the metallic body, which is the central plane bisecting depth A of the metallic body in FIG. 1. In one embodiment, the local reinforcing segment depth X terminates at a location no more than about 45% of the depth A of the metallic body. In another embodiment the local reinforcing segment depth X terminates at a location no more than about 35% of the depth A of the metallic body.

In one embodiment of the invention, the proportion of the reinforcing composition in the local reinforcing segment 18 (such as 10 vol. % SiC) and the depth X of the local reinforcing segment are selected as a function of a predicted stiffness of the locally reinforced structural component in comparison to a predicted stiffness of a monolithic structural component having the same overall reinforcing composition proportion. The overall reinforcing composition proportion is first determined. That is, if the locally reinforced structural component has a reinforcing segment which is 10% SiC and 90% Al, the percentage of SiC in the overall component is determined. For example, depending on the overall dimensions of the component, this may calculate to 0.8 vol. % of the overall structure:
(Vol. % in section)×{(X×Y)/(A×B)}=equivalent reinforcement % in monolithic beam
0.1×{(0.5×8)/(5×10)}=0.8 vol. % SiC

This calculation applies to the configuration in FIG. 1 where the reinforcing segment and the structural component are rectangular. Components X, Y, A, and B are dimensions used to calculate cross-sectional areas of the reinforcing segment and structural component where both are generally rectangular. X×Y calculates a cross-sectional area of the reinforcing segment, and A×B calculates a cross-sectional area of the overall component. These components may not be rectangular in all instances. A more general formula encompassing rectangular as well as non-rectangular configuration is as follows:
(Vol. % in section)×{(Cᵣ)/C_{b})};

wherein Vol. % in section is a volume % of reinforcing composition in the reinforcing segment, Cᵣ is an average area of cross-section of the reinforcing segment taken perpendicular to a lengthwise axis of the component, and C_{b} is an average area of cross-section of the component taken perpendicular to the same lengthwise axis of the component.

The stiffness of the respective components (locally reinforced v. monolithic) are then determined and compared, and the reinforcing composition proportion and depth are selected such that the locally reinforced component has a greater predicted stiffness.

The deflection of the locally reinforced component under a selected load is calculated using commercially available software which employs finite element analysis (FEA) such as a software package distributed by M.S.C. Software under the trade name MARC. This software is used in the structural engineering field, and is specifically designed, for generating deflection data for composites of known materials. See http://www.marc.com/Support/Library/Features_of_Marc_{—}2001.pdf. Finite element analysis involves simulating the structure's behavior by a computer model such as in the MARC software which breaks the structure down into an assembly of finite-sized elements. The behaviors of the constituent elements and the overall structure are predicted by a system of relationships and equations readily solved with computer processors. The paper Widjaja, B. R., Chapter 4, Strength and Stiffness Predictions of Composite Slabs by Finite Element Model, Analysis and Design of Steel Deck-Concrete Composite Slabs, October 1997 notes that FEA is an accurate method for predicting composite beam deflection (http://scholar.lib.vt.edu/theses/available/etd-92397-13240/unrestricted/Ch4.pdf).

The deflection of the monolithic component under the selected load is calculated using the rule of mixtures as described above.

The foregoing two calculated values—deflection of each beam with local reinforcement as calculated by finite element analysis, and deflection of each comparative monolithic beam having the same overall reinforcement %—are compared to yield a deflection ratio comparing local reinforcement to monolithic reinforcement. A deflection ratio of less than 1 represents synergistic reinforcement in that the predicted deflection in the locally reinforced component is less, and the predicted stiffness greater, than of a monolithic beam as calculated by the rule of mixtures.

As demonstrated in more detail below in Example 1, deflection ratios are calculated for at least several variations of locally reinforced components which differ from each other in terms of location of reinforced segment, depth of reinforced segment and, optionally, proportion of reinforcing material in the reinforced region. These several deflection ratios are evaluated and a combination of reinforcement depth, location, and reinforcing material proportion is selected which corresponds to a deflection ratio of less than 1.

In another aspect this invention is directed to a method for incorporating a local reinforcing segment into a component. A rotating pin or tool is contacted with the surface of a metal body. Friction between the rotating pin and the bulk metal results in localized heating which permits the pin to be plunged into the metal. In front of the pin there is a supply of reinforcing composition particles which are incorporated into the bulk metal by the rotating pin.

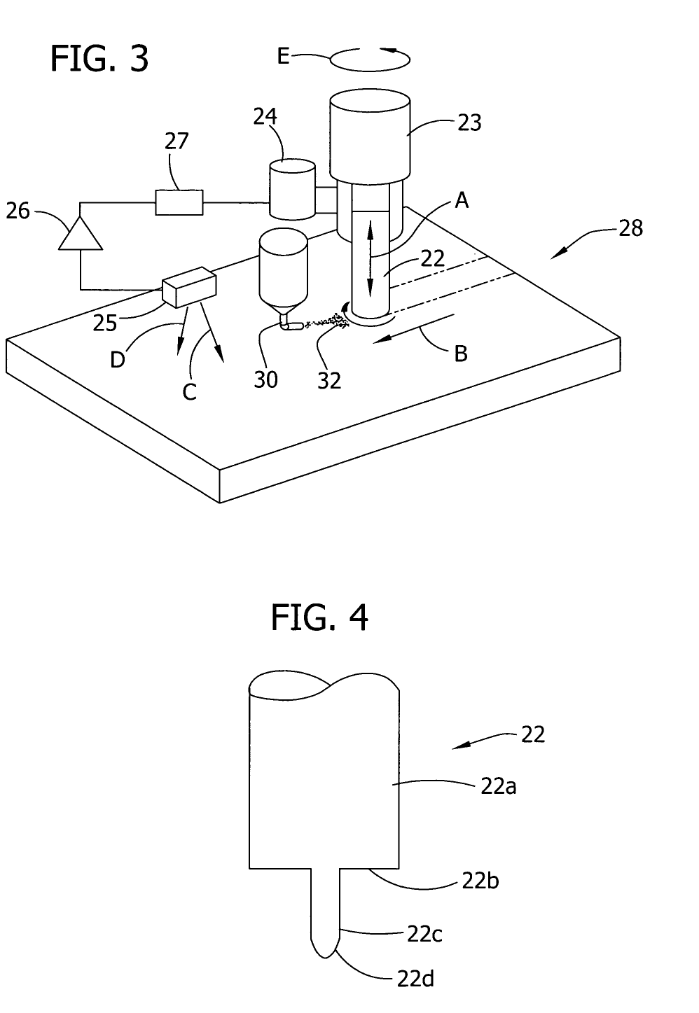

One device suitable to be operated according to the parameters of the invention to perform the method of the invention is disclosed in U.S. Pat. No. 6,299,050 and illustrated in FIGS. 3 and 4 herein. There is a tool 22, a rotation driver 23, and a vertical driver 24 for moving the tool up and down along the direction A of its rotation axis. Detector 25 is mounted at a predetermined position with respect to the tool, travels with the tool, and detects distance to the surface of the workpiece 28. Signal processor 26 and vertical controller 27 cooperate to control the vertical position of the tool. The rotation driver 23 and vertical driver 24 are mounted on a movable frame for moving relative to the workpiece in a direction such as directions B, C, and D. The device as shown in the '050 patent is modified as shown here by incorporation of a hopper 30 which is a source of reinforcing composition powder 32.

As illustrated in FIG. 4, the tool 22 disclosed schematically in U.S. Pat. No. 6,299,050 and suitable for use in connection. with the present invention has a base 22a, a shoulder portion, 22b, a tip portion 22c, and a tip 22d.

Once a required surface temperature and softness are reached, the pin is plunged into the bulk metal to a particular depth, and then moved to traverse through the metal. As the pin traverses the bulk metal, the metal moves in a complicated manner from the leading edge of the pin to around the trailing edge of the pin. The reinforcing powder composition 32 is incorporated into the bulk metal 28 by the action of the rotating pin. Conditions such as rotation speed, pin geometry, traverse speed, and tool tilt angle are selected so that the movement of bulk metal is such that bulk metal completely closes in around the pin at the trailing edge, leaving solid metal at the surface and through the complete depth to which the pin was plunged.

One of the parameters which is adjusted to yield a reinforcement segment of desired geometry is the traverse speed of the pin. As a general proposition, for certain materials, the traverse speed is from about 0.5 inches/min (ipm) to about 24 ipm, and the rotation is from about 200 rpm to about 2000 rpm. For a particular metal, pin geometry, and pin rotation speed, varying the traverse speed varies the reinforcement section geometry. In carrying out the invention it is typically necessary to run a number of trials to determine the combination of traverse speed, rotation, and tool geometry which produces the desired reinforcement.

The depth of reinforcement is controlled in one embodiment by using pins of differing lengths. In another embodiment the depth of the reinforcement is controlled in one embodiment by raising and lowering the pin to different depths within the metal body. This can be accomplished, for example, by simply raising and lowering the pin using the controller set up illustrated in FIG. 3, or by using a retractable friction stir tool of the type disclosed in U.S. Pat. No. 5,718,366.

In one preferred embodiment of the invention, one, two, or more slots or grooves are machined into the surface of the bulk metal. These slots or grooves are filled with metal powder to assist incorporation of the powder into the metal body by friction stirring. This technique leads to more uniform distribution of the powder in the bulk metal.

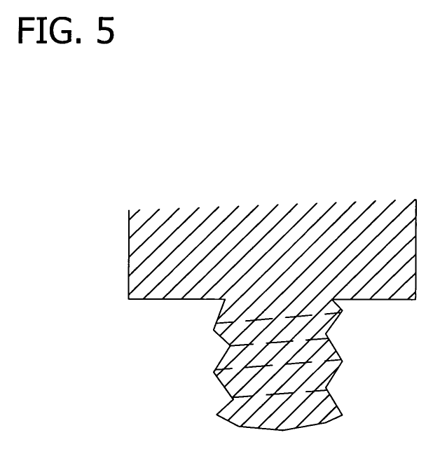

The pin is preferably threaded in such a manner as shown in FIG. 5 to facilitate introduction of the reinforcement material. This thread design is also shown in co-assigned published U.S. application Ser. No. 10/261,036, publication number 2004/0060965, incorporated by reference. While in the prior application the pin was threaded circumferentially downwardly in the clockwise direction for displacement of metal (i.e., formation of a hole) upon counterclockwise rotation of the pin, in the present arrangement the pin is threaded circumferentially downwardly in the clockwise for incorporation of the reinforcement material into the bulk metal upon clockwise rotation of the pin. In other words, the same pin is used, but it is rotated in a direction opposite to the rotation direction in the prior application. The movement of material and therefore the shape and location of the reinforcement section can be manipulated by choice of thread direction and thread design. Friction stirring tools of the type suitable for carrying out the friction stirring component of the invention are known in the art as disclosed, for example, in U.S. Pat. Nos. 5,460,317; 5,718,366; 6,227,430; 6,138,895; 5,794,835; and 6,299,050, all expressly incorporated by reference.

A further variation on the pin design relates to the texture of the portion of the shoulder which contacts the bulk metal. In one embodiment the shoulder is smooth; in another embodiment it bears a scroll pattern. Without a scroll pattern, preliminary results show the shape of the local reinforced segment is generally elliptical, as in the working Examples 2 and 3 below. With a scroll pattern, these results show the shape of the scroll pattern is more basin-like, with a larger portion of the reinforcing segment intersecting the top surface of the substrate.

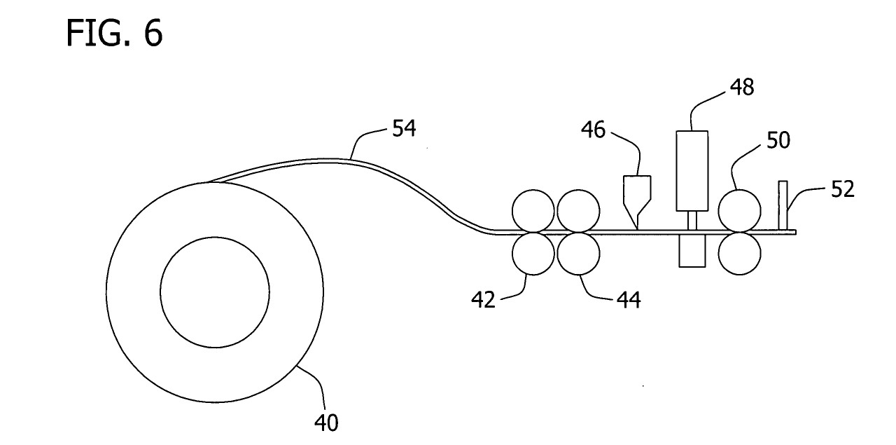

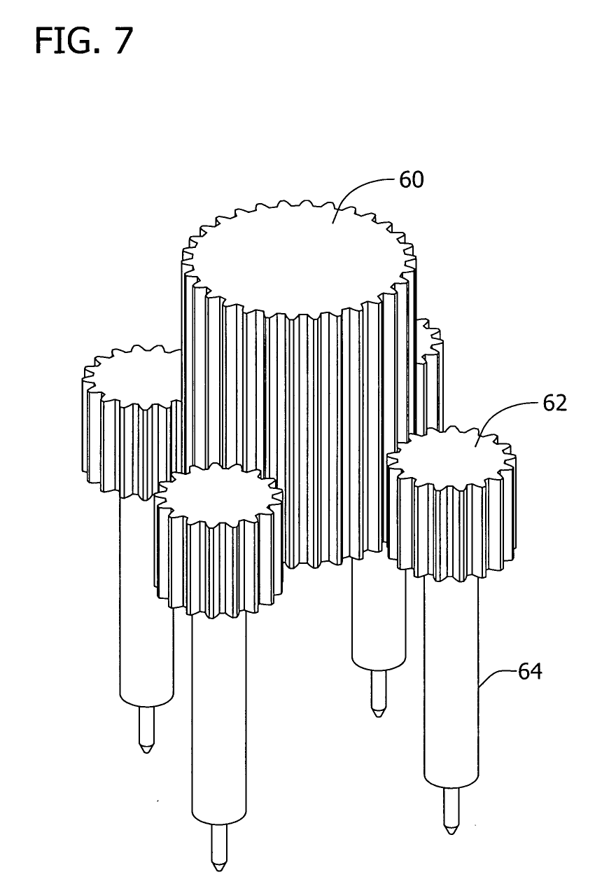

In the context of a beam manufacturing process, in one preferred embodiment the invention employs a so-called “Properzi” mill as modified for the present invention. This is illustrated schematically in FIG. 6, which shows a source of aluminum or other metal 40, section roller 42, groove roller 44, powder hopper 46, friction stir station 48, section groove roller 50, and shearing mill 52. The bulk material is shown here as sheet stock, but in other embodiments it is bar or rod stock. The bulk material 54 is drawn through the respective section roller 42 which imparts desired thickness to the material 54. It is drawn through the groove roller 44 which forms a groove in the sheet 54 into which hopper 46 dispenses reinforcing composition powder. The friction stir stand 48 incorporates the reinforcing composition powder into the sheet by friction stir processing. Section roller 50 imparts desired final shape, thickness, and overall cross-section. Shearing mill 52 cuts the reinforced material into segments of desired length.

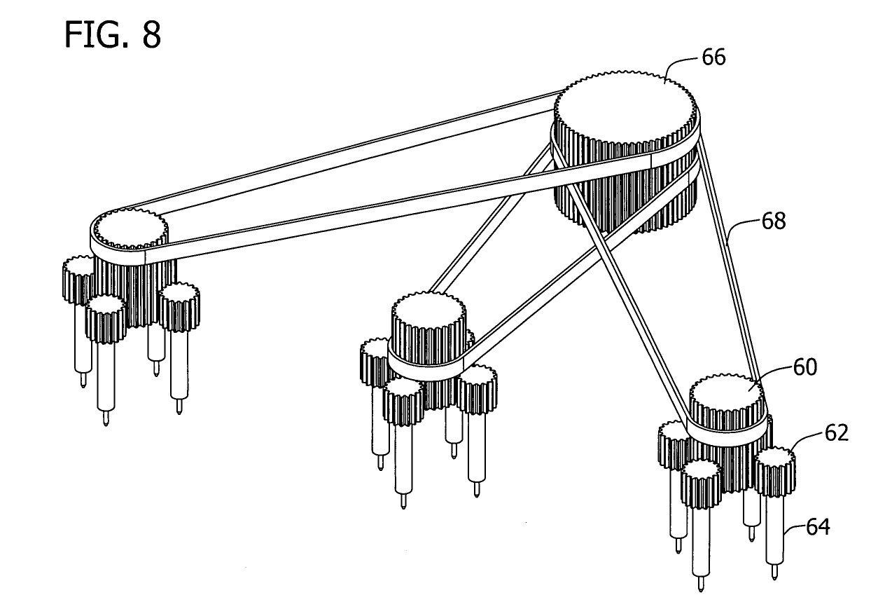

In one embodiment the invention employs one or more cluster tools as illustrated schematically in FIGS. 7 and/or 8 for incorporating the reinforcing composition into the bulk metal. This arrangement facilitates formation of a wider reinforcing segment in a single pass than does an arrangement with a single friction stir tool. There is a drive gear 60 which communicates with a plurality of driven gears 62 to rotate a plurality of friction stir tools 64. This cluster tool may be used by itself, or with additional cluster tools as shown in FIG. 8 wherein a drive gear 66 drives the tools via drive belts 68.

The invention is further illustrated by the following example.

### EXAMPLE 1

Beam deflection data for 5083 Al beams reinforced with SiC were generated and analyzed to determine what combinations of reinforcement location and reinforcement vol. % yield synergistic results. That is, they were analyzed to determine what combinations yield predicted stiffnesses greater than maximum theoretical stiffnesses as calculated by the rule of mixtures. The beams were 5 mm by 10 mm in cross-section with a reinforced region 8 mm wide; i.e., referring to FIG. 1, A=5 mm, B=10 mm, and Y=8 mm. Various combinations of SiC % (10%, 20%, and 30% by volume SiC in the reinforced region) and depth of reinforcement (0.5, 1.0, 1.5, 2.0, and 2.5 mm) were analyzed. As a first calculation, deflection data under a preselected load of 1000 newtons for 15 beams representing all possible combinations of these SiC percentages and these reinforcement depths were generated using a commercially available software package distributed by M.S.C. Software under the trade name MARC. This software is used in the structural engineering field, and is specifically designed, for generating deflection data by finite element analysis (FEA) for composites of known materials.

As a second calculation, for each of the foregoing combinations of SiC % and reinforcement depth, the SiC % by volume of the entire beam was calculated. For example, it was calculated that a beam with a reinforcement section constituting 10 vol. % SiC in the reinforcement segment having a depth of 0.5 mm had the same amount of SiC as a monolithic beam with 0.8 vol. % SiC homogeneously distributed throughout:
(Vol. % in section)×{(X×Y)/(A×B)}=equivalent reinforcement % in monolithic beam
0.1×{(0.5×8)/(5×10)}=0.8 vol. % SiC

The fifteen calculated data points were as follows:

| Vol % of SiC | | | | | |
|---|---|---|---|---|---|
| in Selective | Reinforced Layer Depth - X (mm) | | | | |
| Region | 0.5 | 1.0 | 1.5 | 2.0 | 2.5 |
| 10 | 0.8 | 1.6 | 2.4 | 3.2 | 4.0 |
| 20 | 1.6 | 3.2 | 4.8 | 6.4 | 8.0 |
| 30 | 2.4 | 4.8 | 7.2 | 9.6 | 12.0 |

For each of these 15 data points, deflection values were calculated using the rule of mixtures.

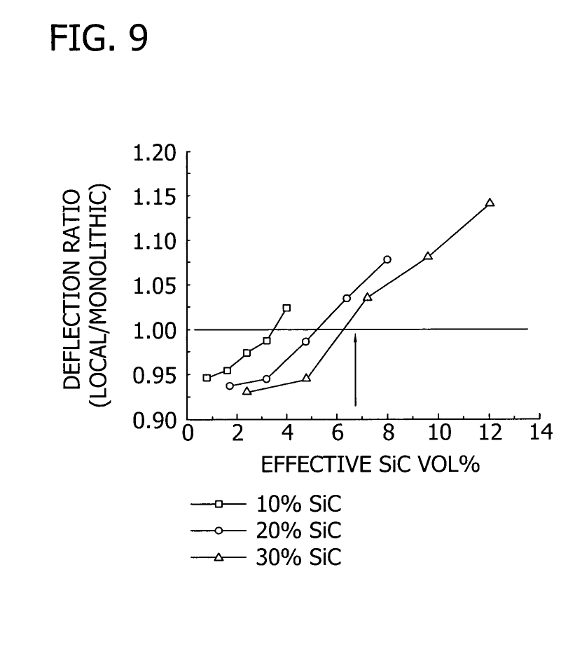

The foregoing two calculated values—deflection of each beam with local reinforcement as calculated by MARC, and deflection of each comparative monolithic beam having the same overall reinforcement %—were compared to yield a deflection ratio comparing local reinforcement to monolithic reinforcement. These data are presented in FIG. 9, and reveal the following:
a) a deflection ratio of less than 1 is achieved by reinforcement with 10 vol. % SiC to depths of 0.5, 1.0, 1.5, and 2.0 mm;
b) a deflection ratio of less than 1 is achieved by reinforcement with 20 vol. % SiC to depths of 0.5, 1.0, and 1.5 mm; and
c) a deflection ratio of less than 1 is achieved by reinforcement with 30 vol. % SiC to depths of 0.5 and 1.0 mm.

A deflection ratio of less than 1 represents synergistic reinforcement in that the predicted deflection is less, and the predicted stiffness greater, than of a monolithic beam as calculated by the rule of mixtures.

These data also show that the best results are obtained for thin selectively reinforced regions, i.e., for those regions representing a reinforcement depth on the order of 1.0 mm and less. Also, when the reinforcement depth is 2.5 mm, such that it touches the neutral line (center of beam) of the 5 mm thick beam, the selectively reinforced composite is worse than the comparable monolithic beam (uniformly reinforced beam).

The enhancement for thinner layers is shown to be as much as 7%, as the deflection ratio is on the order of 0.93. The implication is that for same design stiffness, up to 7% weight saving results from synergistic design within the range considered here.

The samples which demonstrated enhanced properties in FIG. 9 all had overall effective SiC volume % of less than about 10%, and even less than about 7%. However, the curve will be different for materials other than SiC in Al alloy, such that this value of about 10% will not apply to all combinations.

### EXAMPLE 2

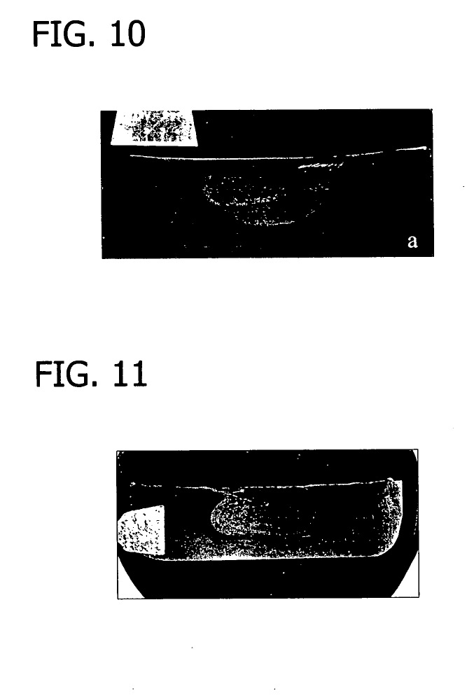

An Al beam reinforced by a WC reinforcing segment was prepared in accordance with the invention and a photograph of a cross-section thereof is shown in FIG. 10. The arrangement of the friction stir tool was as is shown schematically in FIG. 3. The operation parameters were 600 rpm tool rotation speed, 1.0 inch/minute traverse speed, 0.18 inch pin length, and 0.18 inch plunge depth. The tool had a tilt angle of 3.5 degrees. Prior to placement of the powder on the substrate, two grooves were formed which were 2 mm wide, 1 mm deep, and 1.5 mm apart. The reinforced section is the central section which appears lighter in the photograph. The volume fraction of WC in the reinforced section was approximately 3%. The width and depth of the beam were approximately 75 mm×12.5 mm and the width and depth of the reinforcing segment were approximately 7 mm×3 mm.

### EXAMPLE 3

An Al beam reinforced by a WC reinforcing segment was prepared in accordance with the invention and a photograph of a cross-section thereof is shown in FIG. 11. The arrangement of the friction stir tool was as is shown in FIG. 3. The operation parameters were 600 rpm tool rotation speed, 1.0 inch/minute traverse speed, 0.25 inch pin length, and 0.26 inch plunge depth. The tool had a tilt angle of 2.5 degrees. The reinforced section is the central section which appears lighter in the photograph. The volume fraction of WC in the reinforced section was about 3%. The reinforced region is completely embedded within the material bulk and does not intersect the upper surface. This difference between the respective Examples 2 and 3 is attributable to material flow pattern. From preliminary results it is believed this is a function of factors including traverse speed, rotation speed, pin design, tool tilt angle, and shoulder texture, but the exact mechanism has not been determined. It is necessary to manipulate these factors to experimentally arrive at a combination which yields the desired local reinforcement segment configuration. The width and depth of the beam were approximately 75 mm×12.5 mm and the width and depth of the reinforcing segment were approximately 10.5 mm×4 mm. The 4 mm depth began about 1 mm below the surface, and therefore extended from about 1 mm below the surface to about 5 mm below the surface.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements. The term “metal” encompasses pure metals as well as alloys.

As various changes could be made in the above methods without departing from the scope of the invention, it is intended that all matter contained in the above description or shown in the accompanying drawing shall be interpreted as illustrative and not in a limiting sense.

What is claimed is:

1. A method of increasing a modulus of elasticity of a structural beam which comprises a metallic body having a body depth extending from a top surface of the metallic body to an opposing bottom surface of the metallic body, the method comprising:
incorporating a reinforcing segment into the metallic body by friction stir processing to form a composite structural beam comprising the metallic body and the reinforcing segment;
wherein the reinforcing segment comprises a reinforcing composition mixed with material of the metal body; and
wherein the reinforcing composition is a material distinct from the material of the metallic body and has a modulus of elasticity which is greater than a modulus of elasticity of the material of the metallic body.

2. The method of claim 1 wherein the reinforcing segment occupies a reinforcing segment depth beginning at the top surface of the metallic body.

3. The method of claim 1 wherein the reinforcing segment occupies a reinforcing segment depth beginning beneath the top surface of the metallic body.

4. The method of claim 1 wherein the metallic body has a central axis disposed midway between the top and bottom surfaces of the metallic body, and the reinforcing segment does not intersect the central axis.

5. The method of claim 2 wherein the metallic body has a central axis disposed midway between the top and bottom surfaces of the metallic body, and the reinforcing segment does not intersect the central axis.

6. The method of claim 3 wherein the metallic body has a central axis disposed midway between the top and bottom surfaces of the metallic body, and the reinforcing segment does not intersect the central axis.

7. The method of claim 1 wherein the reinforcing segment occupies a reinforcing segment depth extending to at least about 0.5 mm beneath the top surface of the metallic body and terminating within the metallic body.

8. The method of claim 2 wherein the reinforcing segment depth extends to at least about 0.5 mm beneath the top surface of the metallic body and terminates within the metallic body.

9. The method of claim 3 wherein the reinforcing segment depth extends to at least about 0.5 mm beneath the top surface of the metallic body and terminates within the metallic body.

10. The method of claim 4 wherein the reinforcing segment occupies a reinforcing segment depth extending to at least about 0.5 mm beneath the top surface of the metallic body and terminating within the metallic body.

11. The method of claim 5 wherein the reinforcing segment depth extends to at least about 0.5 mm beneath the top surface of the metallic body and terminates within the metallic body.

12. The method of claim 6 wherein the reinforcing segment depth extends to at least about 0.5 mm beneath the top surface of the metallic body and terminates within the metallic body.

13. The method of claim 1 wherein the composite structural beam has an overall effective reinforcing composition volume proportion of less than about 10% calculated as follows:
(Vol. % in section)×{(Cᵣ)/C_{b})};
wherein Vol. % in section is a volume % of reinforcing composition in the reinforcing segment, Cᵣ is an average area of a cross-section of the reinforcing segment taken perpendicular to a lengthwise axis of the beam, and C_{b} is an average area of a cross-section of the beam taken perpendicular to the lengthwise axis of the beam.

14. The method of claim 4 wherein the composite structural beam has an overall effective reinforcing composition volume proportion of less than about 10% calculated as follows:
(Vol. % in section)×{(Cᵣ)/C_{b})};
wherein Vol. % in section is a volume % of reinforcing composition in the reinforcing segment, Cᵣ is an average area of a cross-section of the reinforcing segment taken perpendicular to a lengthwise axis of the beam, and C_{b} is an average area of a cross-section of the beam taken perpendicular to the lengthwise axis of the beam.

15. The method of claim 7 wherein the composite structural beam has an overall effective reinforcing composition volume proportion of less than about 10% calculated as follows:
(Vol. % in section)×{(Cᵣ)/C_{b})};
wherein Vol. % in section is a volume % of reinforcing composition in the reinforcing segment, Cᵣ is an average area of a cross-section of the reinforcing segment taken perpendicular to a lengthwise axis of the beam, and C_{b} is an average area of a cross-section of the beam taken perpendicular to the lengthwise axis of the beam.

16. The method of claim 1 wherein the material of the metallic body is selected from the group consisting of Al and Al alloys.

17. The method of claim 16 wherein the reinforcing composition is selected from the group consisting of SiC, WC, B₄C, TiC, carbides, TiB₂, AlN, Al₂O₃, Nb in a Cu matrix, cermets, and combinations thereof.

18. A method of making a composite structural component comprising a metallic body having a body depth extending from a top surface of the metallic body to an opposing bottom surface of the metallic body, the method comprising:
incorporating a reinforcing segment into the metallic body by friction stir processing to form the composite structural component comprising the metallic body and the reinforcing segment;
wherein the reinforcing segment comprises a reinforcing composition mixed with material of the metal body;
wherein the reinforcing composition is a material distinct from the material of the metallic body and has a modulus of elasticity which is greater than a modulus of elasticity of the material of the metallic body; and
wherein the reinforcing segment occupies a reinforcing segment depth extending to at least about 0.5 mm beneath the top surface of the metallic body and terminating within the metallic body.

19. The method of claim 18 wherein the reinforcing segment occupies a reinforcing segment depth beginning at the top surface of the metallic body.

20. The method of claim 18 wherein the reinforcing segment occupies a reinforcing segment depth beginning beneath the top surface of the metallic body.

21. The method of claim 18 wherein the metallic body has a central axis disposed midway between the top and bottom surfaces of the metallic body, and the reinforcing segment does not intersect the central axis.

22. The method of claim 19 wherein the metallic body has a central axis disposed midway between the top and bottom surfaces of the metallic body, and the reinforcing segment does not intersect the central axis.

23. The method of claim 20 wherein the metallic body has a central axis disposed midway between the top and bottom surfaces of the metallic body, and the reinforcing segment does not intersect the central axis.

24. The method of claim 18 wherein the composite structural component has an overall effective reinforcing composition volume proportion of less than about 10% calculated as follows:
(Vol. % in section)×{(Cᵣ)/C_{b})};
wherein Vol. % in section is a volume % of reinforcing composition in the reinforcing segment, Cᵣ is an average area of a cross-section of the reinforcing segment taken perpendicular to a lengthwise axis of the composite structural component, and C_{b} is an average area of a cross-section of the beam taken perpendicular to the lengthwise axis of the composite structural component.

25. The method of claim 19 wherein the composite structural component has an overall effective reinforcing composition volume proportion of less than about 10% calculated as follows:
(Vol. % in section)×{(Cᵣ)/C_{b})};
wherein Vol. % in section is a volume % of reinforcing composition in the reinforcing segment, Cᵣ is an average area of a cross-section of the reinforcing segment taken perpendicular to a lengthwise axis of the composite structural component, and C_{b} is an average area of a cross-section of the beam taken perpendicular to the lengthwise axis of the composite structural component.

26. The method of claim 20 wherein the composite structural component has an overall effective reinforcing composition volume proportion of less than about 10% calculated as follows:
(Vol. % in section)×{(Cᵣ)/C_{b})};
wherein Vol. % in section is a volume % of reinforcing composition in the reinforcing segment, Cᵣ is an average area of a cross-section of the reinforcing segment taken perpendicular to a lengthwise axis of the composite structural component, and C_{b} is an average area of a cross-section of the beam taken perpendicular to the lengthwise axis of the composite structural component.

27. The method of claim 21 wherein the composite structural component has an overall effective reinforcing composition volume proportion of less than about 10% calculated as follows:
(Vol. % in section)×{(Cᵣ)/C_{b})};
wherein Vol. % in section is a volume % of reinforcing composition in the reinforcing segment, Cᵣ is an average area of a cross-section of the reinforcing segment taken perpendicular to a lengthwise axis of the composite structural component, and C_{b} is an average area of a cross-section of the beam taken perpendicular to the lengthwise axis of the composite structural component.

28. The method of claim 18 wherein the material of the metallic body is selected from the group consisting of Al and Al alloys.

29. The method of claim 18 wherein the reinforcing composition is selected from the group consisting of SiC, WC, B₄C, TiC, carbides, TiB₂, AlN, Al₂O₃, Nb in a Cu matrix, cermets, and combinations thereof.

30. A method of making a composite locally reinforced structural component comprising a metallic body having a body depth extending from a first surface of the metallic body to an opposing second surface of the metallic body, and a central axis disposed between the first and second surfaces, wherein the first surface corresponds to a surface of the structural component in compression under primary loading conditions for which the structural component is designed, and the second surface corresponds to a surface of the structural component in tension under primary loading conditions for which the structural component is designed, the method comprising:
incorporating a local reinforcing segment into the metallic body to thereby form the composite locally reinforced structural component comprising the metallic body and the reinforcing segment;
wherein the local reinforcing segment comprises a reinforcing composition mixed with material of the metallic body;
wherein the reinforcing composition is a material distinct from the material of the metallic body and has a modulus of elasticity which is greater than a modulus of elasticity of the material of the metallic body;
wherein the local reinforcing segment has a local reinforcing segment width and a local reinforcing segment depth beginning at or beneath the first surface of the metallic body and terminating within the metallic body;
wherein the proportion of the reinforcing composition in the local reinforcing segment and the depth of the reinforcing segment are selected as a function of a predicted stiffness of the composite locally reinforced structural component in comparison to a predicted stiffness of a monolithic structural component having an overall proportion of reinforcing composition equivalent to an overall proportion of reinforcing composition in the locally reinforced structural component calculated as a function of the reinforcing composition proportion in the local reinforcing segment and the local reinforcing segment depth.

31. The method of claim 30 wherein the incorporating the local reinforcing segment into the metallic body comprises friction stir processing.

32. A method of making a composite locally reinforced structural component, the method comprising:
forming a metallic body having a body depth extending from a first surface of the metallic body to an opposing second surface of the metallic body, wherein the first surface corresponds to a surface of the structural component in compression under primary loading conditions for which the structural component is designed, and the second surface corresponds to a surface of the structural component in tension under primary loading conditions for which the structural component is designed;
incorporating a local reinforcing segment into the metallic body to form the composite locally reinforced structural component comprising the metallic body and the local reinforcing segment;
wherein the local reinforcing segment comprises a reinforcing composition mixed with material of the metal body;
wherein the reinforcing composition is a material distinct from the material of the metallic body and has a modulus of elasticity which is greater than a modulus of elasticity of the material of the metallic body;
wherein the local reinforcing segment has a local reinforcing segment width and a local reinforcing segment depth beginning at or beneath the first surface of the metallic body and terminating within the metallic body;
determining a predicted deflection value of the composite locally reinforced structural component under a predetermined load;
calculating a proportion of reinforcing composition in the structural component as a function of the reinforcing composition proportion in the local reinforcing segment, the local reinforcing segment width, and the local reinforcing segment depth;
calculating a stiffness of a monolithic structural component having a reinforcing composition proportion equal to said proportion of reinforcing composition in the structural component calculated as the function of the reinforcing composition proportion in the local reinforcing segment, the local reinforcing segment width, and the local reinforcing segment depth;
determining a predicted deflection value of the monolithic structural component under said predetermined load; and
selecting the proportion of the reinforcing composition in the local reinforcing segment and the reinforcing segment depth such that a locally reinforced:monolithic deflection ratio R is less than 1, calculated as follows:
the predicted deflection value of the composite locally reinforced structural component under a predetermined load R=÷the predicted deflection value of the monolithic structural component.

33. The method of claim 32 wherein the incorporating the local reinforcing segment into the metallic body comprises friction stir processing.
